(19) United States
(12) Patent Application Publication
(10) Pub. No.: US 2026/0012932 A1
(43) Pub. Date: Jan. 8, 2026

(54) METHOD FOR WIRELESS COMMUNICATION AND TERMINAL DEVICE

(71) Applicant: GUANGDONG OPPO MOBILE TELECOMMUNICATIONS CORP., LTD., Dongguan (CN)

(72) Inventors: Qianxi LU, Dongguan (CN); Bingxue LENG, Dongguan (CN)

(21) Appl. No.: 19/328,085

(22) Filed: Sep. 12, 2025

Related U.S. Application Data
(63) Continuation of application No. PCT/CN2023/081416, filed on Mar. 14, 2023.

(51) Int. Cl. H04W 72/04; H04W 80/02; H04W 80/08

(52) U.S. Cl. CPC H04W 72/04; H04W 80/02; H04W 80/08

(57) ABSTRACT

Provided are a method for wireless communication and a terminal device. The method includes: transmitting user plane upper-layer data directly carried by a physical layer. The method further includes transmitting control plane upper-layer signaling directly carried by the physical layer.

### CROSS-REFERENCE TO RELATED APPLICATION

This application is a continuation of International Application No. PCT/CN2023/081416, filed Mar. 14, 2023, the entire disclosure of which is incorporated herein by reference.

### TECHNICAL FIELD

Embodiments of the present disclosure relate to the field of communication technologies, and in particular, relate to a method for wireless communication, and a terminal device.

### RELATED ART

In related technologies, a method for wireless communication is provided where, for transmission of user plane upper-layer data by a terminal device, the user plane upper-layer data generated by an application layer may be transferred to a physical (PHY) layer through a service data adaptation protocol (SDAP) layer, a packet data convergence protocol (PDCP) layer, a radio link control (RLC) layer, and a medium access control (MAC) layer in sequence, and the user plane upper-layer data is transmitted externally by the physical layer.

However, due to the complexity of the above protocol stack, the complexity of data transmission by the terminal device is relatively high.

### SUMMARY

Embodiments of the present disclosure provide a method for wireless communication, and a terminal device. The technical solutions are as follows:

According to some embodiments of the present disclosure, a method for wireless communication is provided. The method is performed by a terminal device, and the method includes: transmitting user plane upper-layer data directly carried by a physical layer.

According to some embodiments of the present disclosure, a terminal device is provided. The terminal device includes a processor and a memory storing one or more computer programs, wherein the one or more computer programs, when loaded and run by the processor, cause the processor to transmit user plane upper-layer data directly carried by a physical layer.

### BRIEF DESCRIPTION OF DRAWINGS

FIG. 1 is a schematic diagram of a network architecture according to some embodiments of the present disclosure;

FIG. 2 is a schematic diagram of a zero-power terminal device according to some embodiments of the present disclosure;

FIG. 3 is a schematic diagram of a protocol stack according to some embodiments of the present disclosure;

FIG. 4 is a schematic diagram of a protocol stack according to some embodiments of the present disclosure;

FIG. 5 is a flowchart of a method for wireless communication according to some embodiments of the present disclosure;

FIG. 6 is a schematic diagram of a protocol stack according to some embodiments of the present disclosure;

FIG. 7 is a schematic diagram of a protocol stack according to some embodiments of the present disclosure;

FIG. 8 is a schematic diagram of a protocol stack according to some embodiments of the present disclosure;

FIG. 9 is a schematic diagram of a protocol stack according to some embodiments of the present disclosure;

FIG. 10 is a schematic diagram of a protocol stack according to some embodiments of the present disclosure;

FIG. 11 is a flowchart of a method for wireless communication according to some embodiments of the present disclosure;

FIG. 12 is a schematic diagram of a protocol stack according to some embodiments of the present disclosure;

FIG. 13 is a schematic diagram of a protocol stack according to some embodiments of the present disclosure;

FIG. 14 is a schematic diagram of a protocol stack according to some embodiments of the present disclosure;

FIG. 15 is a schematic diagram of a protocol stack according to some embodiments of the present disclosure;

FIG. 16 is a schematic diagram of a protocol stack according to some embodiments of the present disclosure;

FIG. 17 is a block diagram of an apparatus for wireless communication according to some embodiments of the present disclosure; and

FIG. 18 is a schematic structural diagram of a terminal device according to some embodiments of the present disclosure.

### DETAILED DESCRIPTION

For clearer descriptions of the objectives, technical solutions, and advantages of the present disclosure clearer, embodiments of the present disclosure are further described in detail hereinafter with reference to the accompanying drawings.

A network architecture and a service scenario described in the embodiments of the present disclosure are intended to describe the technical solutions according to the embodiments of the present disclosure more clearly, and do not constitute limitations on the technical solutions according to the embodiments of the present disclosure. Those of ordinary skill in the art may understand that, with evolution of the network architecture and emergence of a new service scenario, the technical solutions according to the embodiments of the present disclosure are also applicable to a similar technical problem.

The technical solutions according to the embodiments of the present disclosure are applicable to various communication systems, such as a global system for mobile communication (GSM) system, a code-division multiple access (CDMA) system, a wideband code-division multiple access (WCDMA) system, a general packet radio service (GPRS) system, a long-term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN) system, a wireless fidelity (Wi-Fi) system, a 5th generation (5G) system, or another communication system.

Generally, a conventional communication system supports a limited quantity of connections and is easy to be implemented. However, with development of communication technologies, a mobile communication system supports not only conventional communication modes, but also other communication modes, such as device-to-device (D2D) communications, machine-to-machine (M2M) communications, machine-type communications (MTC), vehicle-to-vehicle (V2V) communications, or vehicle-to-everything (V2X) communications. The embodiments of the present disclosure are also applicable to these communication systems.

The communication system in the embodiments of the present disclosure may be applicable to a carrier aggregation (CA) scenario, a dual connectivity (DC) scenario, and a standalone (SA) networking scenario.

The communication system in the embodiments of the present disclosure may be applicable to an unlicensed spectrum. The unlicensed spectrum may also be considered as a shared spectrum. Alternatively, the communication system in the embodiments of the present disclosure may be applicable to a licensed spectrum. The licensed spectrum may also be considered as an unshared spectrum or a dedicated spectrum.

The embodiments of the present disclosure may be applicable to a terrestrial network (TN) system and the NTN system.

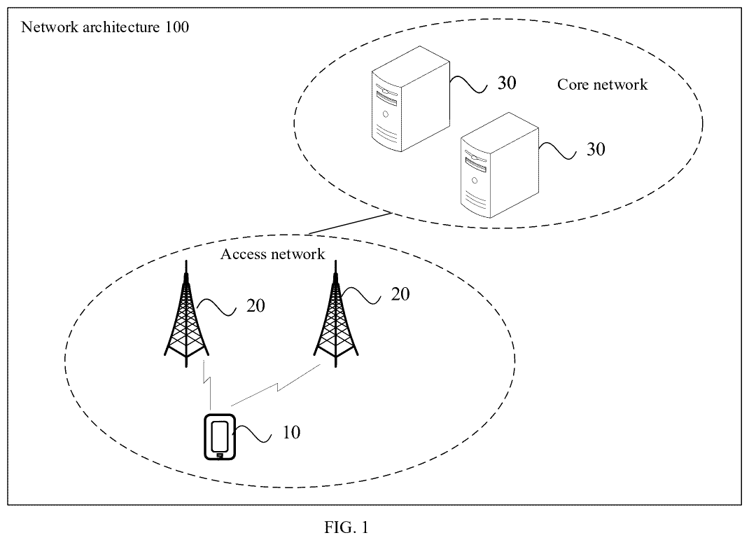

Referring to FIG. 1, a schematic diagram of a network architecture 100 according to some embodiments of the present disclosure is illustrated. The network architecture 100 may involve a terminal device 10, an access network (AN) device 20, and a core network (CN) device 30.

The terminal device 10 may be a user equipment (UE), an access terminal, a subscriber unit, a subscriber station, a mobile station, a mobile platform, a remote station, a remote terminal, a mobile device, a wireless communication device, a user agent, or a user apparatus. In some embodiments, the terminal device 10 may also be a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal device in a 5G system, a terminal device in an evolved public land mobile network (PLMN), or the like, which is not limited in the embodiments of the present disclosure. For convenience of description, the devices mentioned above are collectively referred to as the terminal device. A plurality of terminal devices 10 are usually deployed. At least one terminal device 10 may be distributed in a cell managed by each AN device 20. In the embodiments of the present disclosure, the terms “terminal device” and “UE” are used interchangeably, but those skilled in the art may understand that they generally convey the same meaning.

The AN device 20 is a device deployed in an AN to provide a wireless communication function for the terminal device 10. The AN device 20 may include various forms of macro base stations, micro base stations, relay stations, access points, and the like. In systems employing different radio access technologies, devices with a function of the AN device may have different names, for example, gNodeB or gNB in a 5G NR system. As a communication technology evolves, the name “AN device” may change. For convenience of description, in the embodiments of the present disclosure, the above apparatuses providing the wireless communication function for the terminal device 10 are collectively referred to as the AN device. In some embodiments, a communication relationship may be established between the terminal device 10 and the CN device 30 using the AN device 20. For example, in an LTE system, the AN device 20 may be an evolved universal terrestrial radio access network (EUTRAN) or at least one eNodeB in the EUTRAN. In a 5G NR system, the AN device 20 may be a radio access network (RAN) or at least one gNB in the RAN. In the embodiments of the present disclosure, unless otherwise specified, the term “network device” is the AN device 20, such as a base station.

The CN device 30 is a device deployed in a CN. The CN device 30 mainly functions to provide a user connection, user management and service bearing, and to provide an interface to an external network as a bearer network. For example, CN devices in the 5G NR system may include devices such as an access and mobility management function (AMF) entity, a user plane function (UPF) entity, and a session management function (SMF) entity.

In some embodiments, the AN device 20 communicates with the CN device 30 using a specific air interface technology, such as an NG interface in the 5G NR system. The AN device 20 communicates with the terminal device 10 using a specific air interface technology, such as a Uu interface.

The “5G NR system” in the embodiments of the present disclosure may also be referred to as a 5G system or an NR system, but those skilled in the art may understand its meaning. The technical solutions according to the embodiments of the present disclosure may be applicable to the LTE system, the 5G NR system, an evolved system subsequent to the 5G NR system, a narrowband Internet of things (NB-IoT) system, and other communication systems. This is not limited in the present disclosure.

In the embodiments of the present disclosure, the network device provides a service for a cell. The terminal device communicates with the network device over a transmission resource (for example, a frequency-domain resource or a spectrum resource) on a carrier used by the cell. The cell may be a cell corresponding to the network device (for example, the base station). The cell may belong to a macro base station or a base station corresponding to a small cell. The small cell herein may include a metro cell, a micro cell, a pico cell, a femto cell, and the like. These small cells have the characteristics of small coverage and low transmit power, and are applicable for providing high-rate data transmission services.

Prior to description of the technical solutions of the present disclosure, some background technical knowledge involved in the present disclosure is first explained. The following related technologies, as optional solutions, may be combined with the technical solutions according to the embodiments of the present disclosure in any manner, all of which fall within the protection scope of the embodiments of the present disclosure. The embodiments of the present disclosure include at least part of the following content.

### I. Zero-Power Communication Network

A zero-power communication network is a wireless communication technology applicable to short-range and low-rate applications. Zero-power terminal devices primarily integrate a radio frequency (RF) energy harvesting technology, a backscattering technology, and a low-power computing technology, to achieve an advantage that no power supply is required at the device node.

The core of the RF energy harvesting technology lies in converting RF energy into a direct current. The RF energy may be stored in a battery or a capacitor, or may be directly used to drive a logic circuit, a digital chip, a sensing component, or the like upon being harvested, enabling functions and applications such as modulation and transmission of backscatter signals and collection and processing of sensing information.

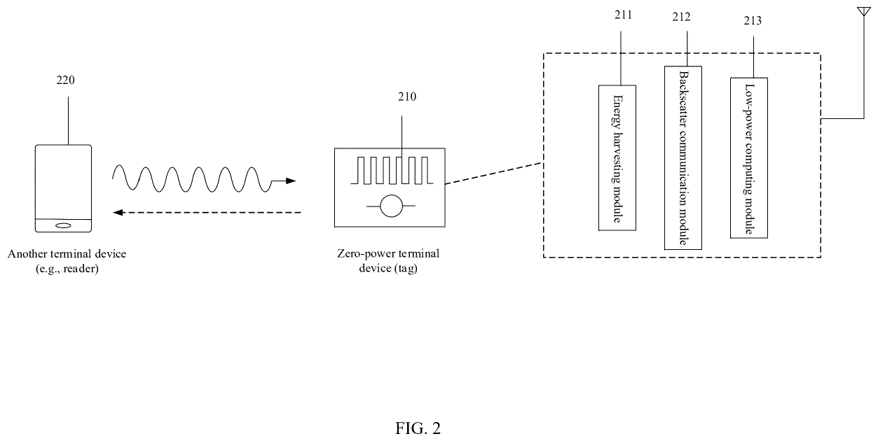

The zero-power communication network is illustrated in FIG. 2. A zero-power terminal device (e.g., a tag) 210 includes an energy harvesting module 211, a backscatter communication module 212, and a low-power computing module 213. The zero-power terminal device (e.g., a tag) 210 communicates with another terminal device (e.g., a reader) 220. In addition, the zero-power terminal device may also communicate with an AN device or a CN device, which is merely illustrated herein as an example.

With the development of 5G systems, the 5G systems in the related art are required to support the zero-power terminal device accessing a network for targeted scenarios which mainly exhibit the following characteristics: extreme environments unsuitable for operation of common terminals; terminals operating with very low power consumption and costs; and battery-free terminals.

The zero-power communication system may be applied in scenarios such as wireless industrial sensing networks, smart agriculture, smart warehousing and logistics, and smart homes.

Based on energy sources and usage modes of zero-power terminal devices, the zero-power terminal devices may be classified into the following three types:

### 1. Passive Zero-Power Terminal Device

A passive zero-power terminal device does not require an internal battery. As the zero-power terminal device approaches a network device (e.g., a reader in a radio frequency identification (RFID) system), the zero-power terminal device enters a near-field range formed by radiation of an antenna of the network device. Thus, an antenna of the zero-power terminal device generates an induced current via electromagnetic induction. The induced current drives a low-power chip circuit of the zero-power terminal device, to implement operations such as demodulation of forward link signals and modulation of reverse link signals. For the backscatter link, the zero-power terminal device uses backscattering techniques for signal transmission.

As evident, the passive zero-power terminal device does not require an internal battery for driving for either the forward link or the reverse link, and thus the passive zero-power terminal device is a true zero-power terminal device.

The passive zero-power terminal device does not require a battery, and has simple RF circuits and baseband circuits. For example, the passive zero-power terminal device does not require components such as a low noise amplifier (LNA), a power amplifier (PA), a crystal oscillator, and an analog-to-digital converter (ADC). Therefore, the passive zero-power terminal device offers many advantages such as a small size, a low weight, a very low price, and a long service life.

Such a terminal device further exhibits the following features: battery-free operation; energy harvesting from the surrounding environment (e.g., radio waves, solar energy, wind energy, or mechanical kinetic energy); absence of a universal subscriber identity module (USIM) card; and limited storage capability of energy from the surrounding environment, though the stored energy is minimal, resulting in significantly fewer supported functional logics compared to common terminal devices.

### 2. Semi-Passive Zero-Power Terminal Device

A semi-passive zero-power terminal device is not equipped with a conventional battery either, but is capability of harvesting radio wave energy by using an RF energy harvesting module and storing the harvested energy in an energy storage unit (e.g., a capacitor). Once energized, the energy storage unit powers a low-power chip circuit of the zero-power terminal device, enabling operations such as demodulation of forward link signals and modulation of reverse link signals. For the backscatter link, the zero-power terminal uses backscattering techniques for signal transmission.

As evident, the semi-passive zero-power terminal device does not require an internal battery for driving for either the forward link or the reverse link. Although the semi-passive zero-power terminal device uses the energy stored in the capacitor during operation, the energy comes from the radio wave energy harvested by the energy harvesting module, and thus the semi-passive zero-power terminal device is also a true zero-power terminal.

The semi-passive zero-power terminal device inherits many advantages of the passive zero-power terminal device, and therefore offers many advantages such as a small size, a low weight, a very low price, and a long service life.

### 3. Active Zero-Power Terminal Device

A zero-power terminal device used in some scenarios may alternatively be an active zero-power terminal device, and such a terminal device may be equipped with an internal battery. The battery is configured to drive a low-power chip circuit of the zero-power terminal device, to implement operations such as demodulation of forward link signals and modulation of reverse link signals. However, for the backscatter link, the zero-power terminal uses backscattering techniques for signal transmission. Thus, the zero-power aspect of such a terminal mainly lies in the fact that signal transmission on the reverse link does not require power of the terminal device, but instead utilizes backscattering.

The active zero-power terminal device uses the internal battery to power an RFID chip to increase a read range of the active zero-power terminal device and improve communication reliability. Therefore, the active zero-power terminal device is applied in some scenarios with high requirements for communication distance, read latency, or the like. Herein, the zero-power terminal device may be a tag, a common device, or the like.

### II. Access Stratum Protocol Stack

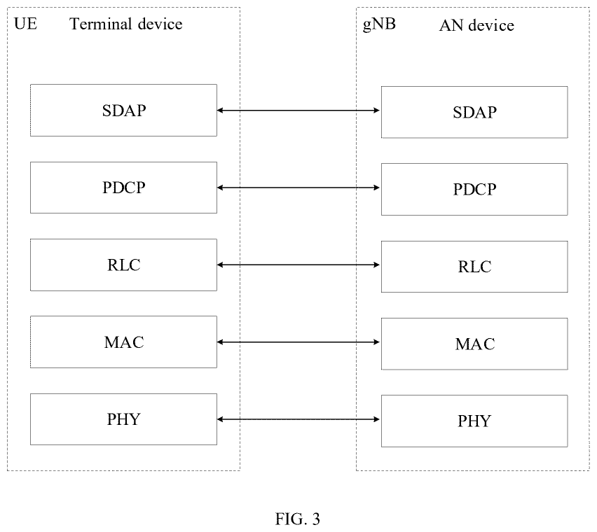

In the related art, the access stratum protocol stack is illustrated in FIG. 3. User plane protocol layers include a PHY layer, an MAC layer, an RLC layer, a PDCP layer, and an SDAP layer. User plane upper-layer data generated by an application layer is transferred to the PHY layer through the SDAP layer, the PDCP layer, the RLC layer, and the MAC layer, and is transmitted by the PHY layer. In some embodiments, a user datagram protocol/transmission control protocol (UDP/TCP) layer and an Internet Protocol (IP) layer may further be included above the SDAP layer and below the application layer. That is, the user plane upper-layer data requires to be transferred through the UDP/TCP layer, the IP layer, the SDAP layer, the PDCP layer, the RLC layer, and the MAC layer prior to reaching the PHY layer. For a reception process, the data is received by the PHY layer, and then transferred to the application layer through the MAC layer, the RLC layer, the PDCP layer, the SDAP layer, the IP layer, and the UDP/TCP layer. The transmission of user plane data is performed between a terminal device and an AN device based on the access stratum protocol stack illustrated in FIG. 3.

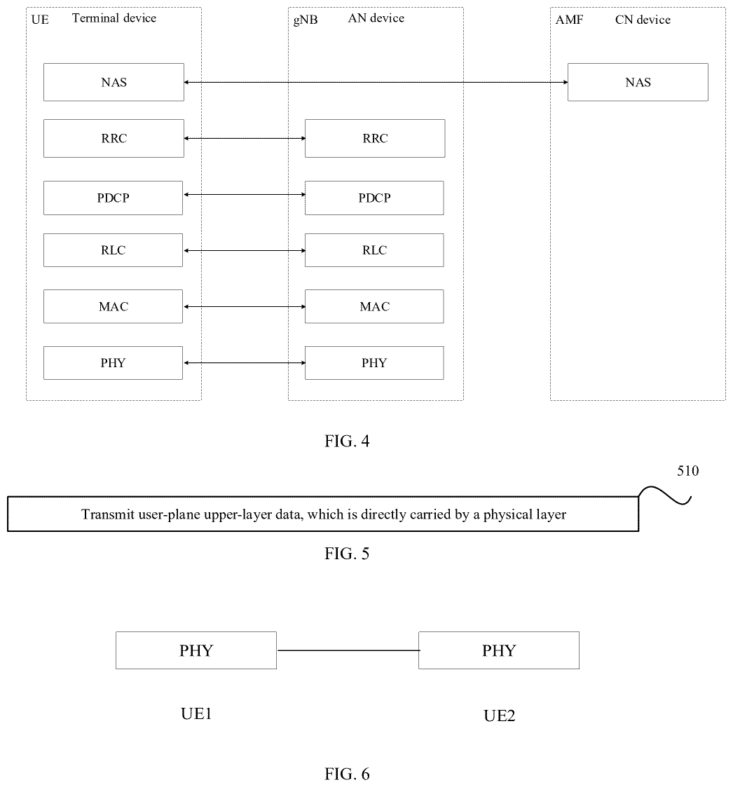

As illustrated in FIG. 4, a control plane protocol layer includes a radio resource control (RRC) layer. Control plane upper-layer signaling generated by the RRC layer is transferred to the PHY layer through layers of the protocol stack, and is transmitted by the PHY layer. The transmission of control plane data is performed between a terminal device and an AN device based on the RRC layer.

In some embodiments, a terminal device and a CN device communicate with each other via a non-access stratum (NAS). Control plane upper-layer signaling generated by the NAS is transferred to the PHY layer through layers of the protocol stack, and the control plane upper-layer signaling is transmitted to the CN device by the PHY layer.

In addition, in sidelink communication, the communication between terminal devices may also be implemented via the above access stratum protocol stack.

However, in the related art, to achieve complex functions, different access strata have been designed to implement these complex functions. For example, the MAC layer is designed to implement the following functions:
mapping between logical channels and transport channels;
multiplexing MAC service data units (MAC SDUs) belonging to one or different logical channels into transport blocks (TBs) delivered to a physical layer on transport channels, or demultiplexing MAC SDUs belonging to one or different logical channels from TBs delivered from a physical layer on transport channels;
scheduling information reporting;
error correction via a hybrid automatic repeat request (HARQ) (one HARQ entity per cell in the case of CA);
priority handling between UEs by means of dynamic scheduling;
priority handling between logical channels of one UE by means of logical channel prioritization;
priority handling between overlapping resources of one UE; and
padding.

The above access stratum protocol stack is excessively complex, resulting in correspondingly highly complex communication procedures based on the above access stratum protocol stack.

Referring to FIG. 5, a flowchart of a method for wireless communication according to some embodiments of the present disclosure is illustrated. The method is applicable to a terminal device, and the method includes the following step 510.

In step 510, the terminal device transmits user plane upper-layer data directly carried by a physical layer.

In some embodiments, transmitting the user plane upper-layer data directly carried by the physical layer refers to sending or receiving the user plane upper-layer data directly carried by the physical layer. In the embodiments, sending the user plane upper-layer data directly carried by the physical layer is used as an example for illustration.

In some embodiments, transmitting the user plane upper-layer data directly carried by the physical layer may occur in transmission of user plane data between terminal devices, or may occur in transmission of user plane data between a terminal device and a network device, which is not limited in the present disclosure.

In some embodiments, the terminal device is a zero-power terminal device.

The user plane upper-layer data refers to user plane data generated by a protocol layer that resides above the physical layer.

In some embodiments, the user plane upper-layer data refers to service data of a user plane, e.g., service data of a voice service. In the embodiments of the present disclosure, a specific service type of the user plane upper-layer data is not limited.

In some embodiments, the user plane upper-layer data is referred to as data, a data bearer, user plane information, or another name, which is not limited in the present disclosure.

In some embodiments, the data bearer refers to a data radio bearer (DRB).

Exemplarily, the user plane upper-layer data is transmitted via the protocol stack illustrated in FIG. 6. The user plane upper-layer data is directly carried by the physical layer. That is, UE1 transmits the user plane upper-layer data to UE2 via a physical layer, and UE2 receives the user plane upper-layer data from UE1 and parses the user plane upper-layer data via a physical layer.

In some embodiments, the user plane upper-layer data includes at least one of: IP-based upper-layer data, Ethernet-based upper-layer data, unstructured upper-layer data, or application layer data.

In TCP/IP protocols, packets that use the IP protocol for data transmission are referred to as IP data packets. Each data packet contains content as specified by the IP protocol. The contents specified by the IP protocol are referred to as IP datagrams or IP data packets. An IP datagram includes two parts, namely, a header (also referred to as a packet header) and data. A first portion of the header has a fixed length of 20 bytes, and is mandatory for all IP data packets. Following the fixed portion of the header are some optional fields with variable lengths. Each IP data packet begins with an IP packet header. A source device constructs the IP packet header, and a destination device processes data by using information encapsulated within the IP packet header. The IP packet header contains extensive information, such as a source IP address, a destination IP address, a data packet length, and an IP version number. Each piece of information, or element, is referred to as a field.

Ethernet is a baseband local area network technology. Ethernet communication is a communication mode in which a coaxial cable is used as a network medium and a carrier sense multiple access with collision detection mechanism is used, achieving a data transmission rate of 1 Gbit/s, which may meet requirements of non-persistent network data transmission.

The application layer is configured to provide a network interface for application programs, and provide services directly to users. The application layer data is application program data.

In some embodiments, the user plane upper-layer data is generated by a protocol layer.

In some embodiments, a first protocol layer for generating the user plane upper-layer data resides above the physical layer.

In some embodiments, the user plane upper-layer data is directly transmitted to the physical layer via the first protocol layer, and the user plane upper-layer data received from the first protocol layer is transmitted via the physical layer. That is, no other protocol layer exists between the first protocol layer and the physical layer, and the user plane upper-layer data generated by the first protocol layer is directly transmitted to the physical layer without being transferred or forwarded by the other protocol layer.

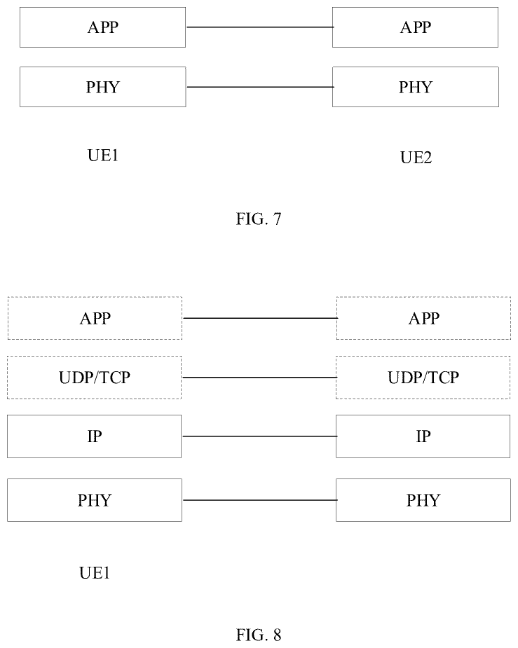

In some embodiments, in a case where the user plane upper-layer data includes application layer data, the first protocol layer includes an application layer. That is, the application layer resides above the physical layer. The application layer data is directly transmitted to the physical layer via the application layer, and the application layer data received from the application layer is transmitted via the physical layer. Exemplarily, as illustrated in FIG. 7, the protocol stack includes an application layer and a physical layer. The application layer generates application layer data and directly transmits the application layer data to the physical layer, and the application layer data received from the application layer is transmitted via the physical layer.

In some embodiments, in a case where the user plane upper-layer data includes IP-based upper-layer data, the first protocol layer includes an IP layer. That is, the IP layer resides above the physical layer. The IP-based upper-layer data is directly transmitted to the physical layer via the IP layer, and the IP-based upper-layer data received from the IP layer is transmitted via the physical layer.

Exemplarily, as illustrated in FIG. 8, the protocol stack includes an IP layer and a physical layer. The IP layer generates IP-based upper-layer data and directly transmits the IP-based upper-layer data to the physical layer, and the IP-based upper-layer data received from the IP layer is transmitted via the physical layer.

Exemplarily, as illustrated in FIG. 8, the protocol stack includes an application layer, a UDP/TCP layer, the IP layer, and the physical layer. The application layer generates user plane upper-layer data and transmits the user plane upper-layer data to the IP layer through the UDP/TCP layer, and the user plane upper-layer data is processed by the IP layer to obtain IP-based upper-layer data. The IP layer transmits the IP-based upper-layer data to the physical layer, and the IP-based upper-layer data received from the IP layer is transmitted via the physical layer.

In some embodiments, in a case where the user plane upper-layer data includes Ethernet-based upper-layer data, the first protocol layer includes an Ethernet layer (or referred to as an 802.1Q layer). That is, the Ethernet layer resides above the physical layer. The Ethernet-based upper-layer data is directly transmitted to the physical layer via the Ethernet layer, and the Ethernet-based upper-layer data received from the Ethernet layer is transmitted via the physical layer.

Exemplarily, as illustrated in FIG. 9, the protocol stack includes an Ethernet layer and a physical layer. The Ethernet layer generates Ethernet-based upper-layer data and directly transmits the Ethernet-based upper-layer data to the physical layer, and the Ethernet-based upper-layer data received from the Ethernet layer is transmitted via the physical layer.

Exemplarily, as illustrated in FIG. 9, the protocol stack includes an IP layer, the Ethernet layer, and the physical layer. The IP layer generates user plane upper-layer data and transmits the user plane upper-layer data to the Ethernet layer, and the user plane upper-layer data is processed by the Ethernet layer to obtain Ethernet-based upper-layer data. The Ethernet layer transmits the Ethernet-based upper-layer data to the physical layer, and the Ethernet-based upper-layer data received from the Ethernet layer is transmitted via the physical layer.

Exemplarily, as illustrated in FIG. 9, the protocol stack includes an application layer, a UDP/TCP layer, the IP layer, the Ethernet layer, and the physical layer. The application layer generates user plane upper-layer data and transmits the user plane upper-layer data to the Ethernet layer through the UDP/TCP layer and the IP layer, and the user plane upper-layer data is processed by the Ethernet layer to obtain Ethernet-based upper-layer data. The Ethernet layer transmits the Ethernet-based upper-layer data to the physical layer, and the Ethernet-based upper-layer data received from the Ethernet layer is transmitted via the physical layer.

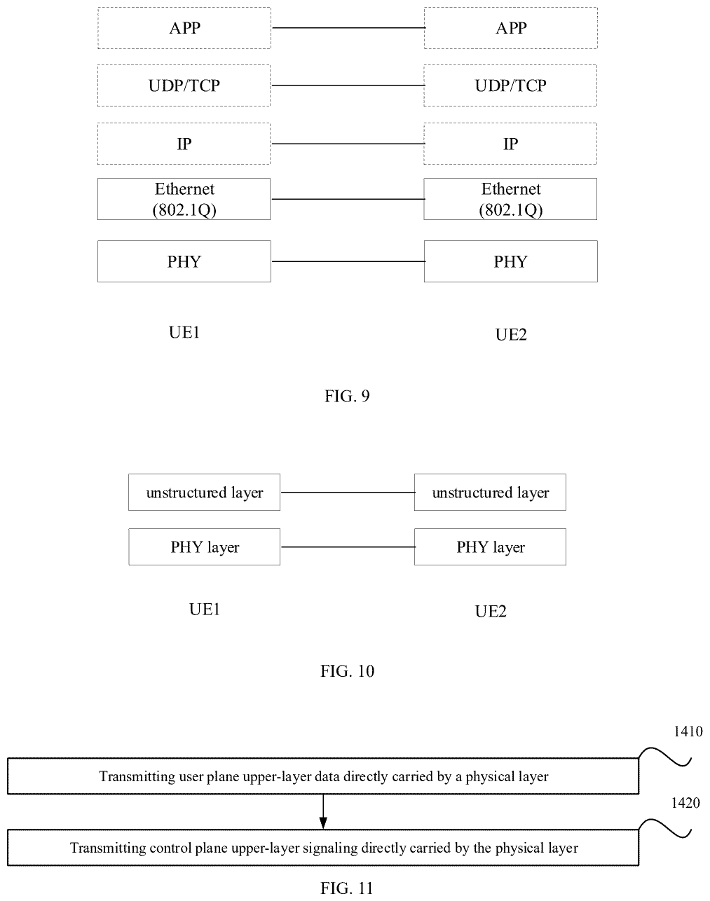

In some embodiments, in a case where the user plane upper-layer data includes unstructured upper-layer data, the protocol stack includes an unstructured layer and a physical layer. As illustrated in FIG. 10, the protocol stack includes an unstructured layer and a physical layer. The unstructured layer generates unstructured upper-layer data and transmits the unstructured upper-layer data to the physical layer, and the unstructured upper-layer data is transmitted via the physical layer.

In some embodiments, the user plane upper-layer data further includes control information. The control information refers to control information generated by a user plane protocol layer above the physical layer, for example, control information generated by an IP layer.

In some embodiments, the method further includes step 520. In step 520, the terminal device transmits indication information via a physical layer control channel, wherein the indication information is used to indicate information related to transmission.

The physical layer control channel may include at least one of: a physical sidelink control channel (PSCCH), a physical uplink control channel (PUCCH), or a physical downlink control channel (PDCCH).

In some embodiments, the indication information is used to indicate at least one of the following information:
presence of data in the transmission;
presence of at least one padding bit in the transmission;
presence of data and at least one padding bit in the transmission;
a length of data carried by the transmission;
a length of at least one padding bit carried by the transmission;
lengths of data and at least one padding bit carried by the transmission; or
a length ratio between data and at least one padding bit carried by the transmission.

The user plane upper-layer data may include at least one of: the data or the at least one padding bit. That is, the user plane upper-layer data may include the data, the at least one padding bit, or both the data and the at least one padding bit.

Exemplarily, the indication information is used to indicate the length of data carried by the transmission, that is, the indication information is used to indicate a quantity of bits occupied by the data carried by the transmission.

Exemplarily, the indication information is used to indicate the length of at least one padding bit carried by the transmission, that is, the indication information is used to indicate a quantity of bits occupied by the at least one padding bit carried by the transmission.

Exemplarily, the indication information is used to indicate the lengths of data and at least one padding bit carried by the transmission, that is, the indication information is used to indicate a quantity of bits occupied by the data carried by the transmission and a quantity of bits occupied by the at least one padding bit carried by the transmission.

Exemplarily, the indication information is used to indicate the length ratio between data and at least one padding bit carried by the transmission, that is, the indication information is used to indicate a ratio between a quantity of bits occupied by the data carried by the transmission and a quantity of bits occupied by the at least one padding bit carried by the transmission. For example, in a case where the data occupies 5 bits and the padding bits occupy 3 bits, the indication information is used to indicate that the length ratio between the data and the at least one padding bit carried by the transmission is 5:3.

According to the technical solutions provided in the embodiments of the present disclosure, the user plane upper-layer data is directly carried and transmitted via the physical layer. The physical layer directly acquires, from a protocol layer that generates user plane upper-layer data, the user plane upper-layer data to be transmitted, eliminating the need for transfer through PDCP, RLC, and MAC layers, thereby reducing the complexity of the protocol stack, simplifying data transmission by the terminal device, and facilitating reducing the power consumption of the terminal device during transmission.

For zero-power terminal devices, which fail to support complex protocol stacks or complex communication procedures, the technical solutions according to the embodiments of the present disclosure reduce the complexity of the protocol stack and simplify transmission, and thus are more suitable for the zero-power terminal devices.

Referring to FIG. 11, a flowchart of a method for wireless communication according to some embodiments of the present disclosure is illustrated. The method is applicable to a terminal device, and the method includes at least one of the following steps 1110 to 1120.

In step 1110, the terminal device transmits user plane upper-layer data directly carried by a physical layer.

In step 1120, the terminal device transmits control plane upper-layer signaling directly carried by the physical layer.

In some embodiments, transmitting the control plane upper-layer signaling directly carried by the physical layer includes sending or receiving the control plane upper-layer signaling directly carried by the physical layer.

In some embodiments, the control plane upper-layer signaling refers to control signaling generated by a protocol layer that resides above the physical layer. For example, the control plane upper-layer signaling refers to signaling for controlling the establishment, maintenance, and release of call procedures. In the embodiments of the present disclosure, specific functions and content of the control plane upper-layer signaling are not limited.

In some embodiments, the control plane upper-layer signaling includes at least one of: RRC layer signaling or NAS signaling.

The RRC layer signaling refers to signaling from an RRC layer, and the NAS signaling refers to signaling from an NAS.

In some embodiments, a second protocol layer for generating the control plane upper-layer signaling resides above the physical layer.

In some embodiments, the control plane upper-layer signaling is directly transmitted to the physical layer via the second protocol layer; and the control plane upper-layer signaling received from the second protocol layer is transmitted via the physical layer.

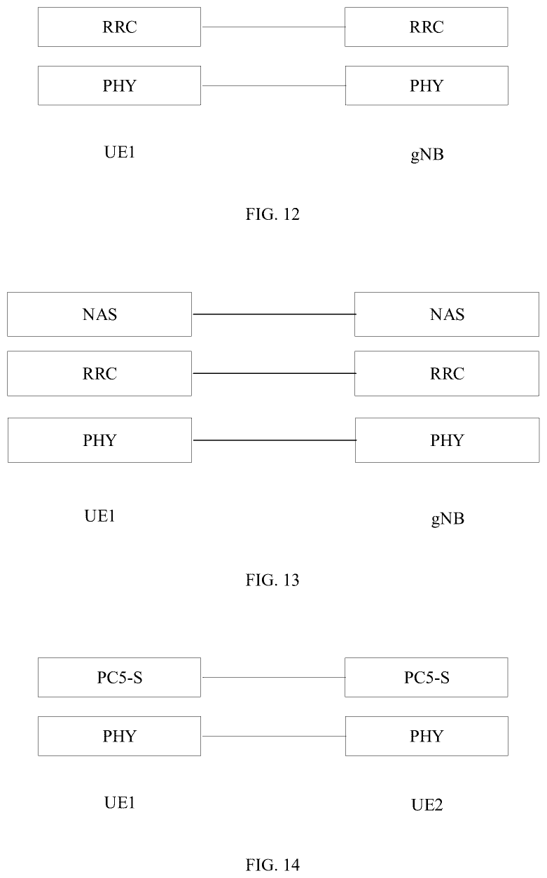

In some embodiments, the control plane upper-layer signaling includes RRC layer signaling, that is, the second protocol layer includes an RRC layer, which resides above the physical layer. The RRC layer signaling is directly transmitted to the physical layer via the RRC layer, and the RRC signaling received from the RRC layer is transmitted via the physical layer. Exemplarily, as illustrated in FIG. 12, the protocol stack includes an RRC layer and a physical layer. The RRC layer directly transmits RRC layer signaling to the physical layer, and the RRC layer signaling received from the RRC layer is transmitted via the physical layer.

In some embodiments, in uplink or downlink communication, the control plane upper-layer signaling includes NAS signaling, that is, the second protocol layer includes an NAS, which resides above the physical layer. The NAS signaling is transmitted to the RRC layer via the NAS, the NAS signaling is directly transmitted to the physical layer via the RRC layer, and the NAS signaling received from the RRC layer is transmitted via the physical layer.

Exemplarily, as illustrated in FIG. 13, the protocol stack includes an NAS, an RRC layer, and a physical layer. The NAS transmits NAS signaling to the RRC layer, the RRC layer directly transmits the NAS signaling to the physical layer, and the NAS signaling received from the RRC layer is transmitted via the physical layer.

In some embodiments, in sidelink communication, the control plane upper-layer signaling further includes sidelink control signaling, for example, ProSe communication 5-signal (PC5-S) signaling. A sidelink control protocol layer (for example, a PC5-S layer) generates sidelink control signaling and directly transmits the sidelink control signaling to the physical layer, and the sidelink control signaling from the sidelink control protocol layer is transmitted via the physical layer. The sidelink control signaling refers to control signaling related to sidelink communication as generated by a control plane protocol layer above the physical layer.

Exemplarily, as illustrated in FIG. 14, the protocol stack includes a PC5-S layer and a physical layer. The PC5-S layer generates PC5-S signaling and directly transmits the PC5-S signaling to the physical layer, and the PC5-S signaling received from the PC5-S layer is transmitted via the physical layer.

In some embodiments, the transmitted user plane upper-layer data and control plane upper-layer signaling are combined arbitrarily. During transmission, a first protocol layer for generating user plane upper-layer data carried by the physical layer and a second protocol layer for generating control plane upper-layer signaling carried by the physical layer are sufficient for the protocol stack. For protocol layers corresponding to user plane upper-layer data not carried by the physical layer and protocol layers corresponding to control plane upper-layer signaling not carried by the physical layer, invocation may be omitted during communication procedures.

Exemplarily, in a case where the user plane upper-layer data carried by the physical layer includes application layer data and where the control plane upper-layer signaling carried by the physical layer includes RRC layer signaling, the protocol stack includes an RRC layer, an application layer, and a physical layer, without requiring invocation of an IP layer, an Ethernet layer, or an NAS.

In some embodiments, the second protocol layer for generating the control plane upper-layer signaling is a protocol layer for an interface between terminals or a protocol layer for an interface between a terminal and a network.

Exemplarily, the RRC layer may be an RRC layer for an interface between terminals, or an RRC layer for an interface between a terminal and a network.

In some embodiments, the RRC layer is an RRC layer between a zero-power terminal device and a read device, e.g., an RRC layer between a tag and a reader; or, the RRC layer is an RRC layer between a network device and a zero-power terminal device, e.g., an RRC layer between a network device and a tag.

Exemplarily, the NAS may be an NAS for an interface between terminals, e.g., PC5-S, or an NAS for an interface between a terminal and a network.

In some embodiments, the NAS is an NAS between a zero-power terminal device and a read device, e.g., an NAS between a tag and a reader; or, the NAS is an NAS between a network device and a zero-power terminal device, e.g., an NAS between a network device and a tag.

In some embodiments, the method further includes step 1130. In step 1130, the terminal device transmits indication information via a physical layer control channel, wherein the indication information is used to indicate information related to transmission.

In some embodiments, the indication information indicates at least one of the following information:
presence of data in the transmission;
presence of signaling in the transmission;
presence of at least one padding bit in the transmission;
presence of data and signaling in the transmission;
presence of data and at least one padding bit in the transmission;
presence of signaling and at least one padding bit in the transmission;
presence of data, signaling, and at least one padding bit in the transmission;
a length of data carried by the transmission;
a length of signaling carried by the transmission;
a length of at least one padding bit carried by the transmission;
lengths of data and signaling carried by the transmission;
lengths of data and at least one padding bit carried by the transmission;
lengths of signaling and at least one padding bit carried by the transmission;
lengths of data, signaling, and at least one padding bit carried by the transmission;
a length ratio between data and signaling carried by the transmission;
a length ratio between data and at least one padding bit carried by the transmission;
a length ratio between signaling and at least one padding bit carried by the transmission; or
a length ratio of data, signaling, and at least one padding bit carried by the transmission.

The user plane upper-layer data transmitted by the physical layer may include the data and the at least one padding bit, and the control plane upper-layer signaling may include the signaling and the at least one padding bit. The transmission may carry user plane upper-layer data and control plane upper-layer signaling. That is, the transmission may carry the data, the signaling, the at least one padding bit, both the signaling and the at least one padding bit, both the data and the at least one padding bit, or all of the data, the signaling, and the at least one padding bit.

Exemplarily, the indication information is used to indicate the length of at least one padding bit carried by the transmission, that is, the indication information is used to indicate a quantity of bits occupied by the at least one padding bit carried by the transmission.

Exemplarily, the indication information is used to indicate the lengths of signaling and at least one padding bit carried by the transmission, that is, the indication information is used to indicate a quantity of bits occupied by the signaling carried by the transmission and a quantity of bits occupied by the at least one padding bit carried by the transmission.

Exemplarily, the indication information is used to indicate the length ratio between signaling and at least one padding bit carried by the transmission, that is, the indication information is used to indicate a ratio between a quantity of bits occupied by the signaling carried by the transmission and a quantity of bits occupied by the at least one padding bit carried by the transmission. For example, in a case where the signaling occupies 5 bits and the padding bits occupy 3 bits, the indication information indicates that the length ratio between signaling carried by the transmission and at least one padding bit carried by the transmission is 5:3.

Exemplarily, the indication information is used to indicate presence of data, signaling, and at least one padding bit in the transmission, that is, the transmission carries user plane upper-layer data, control plane upper-layer signaling, and at least one padding bit.

Exemplarily, the indication information is used to indicate presence of data and signaling in the transmission, that is, the transmission carries user plane upper-layer data and control plane upper-layer signaling.

Exemplarily, the indication information is used to indicate the lengths of data and signaling carried by the transmission, that is, the indication information is used to indicate a quantity of bits occupied by the user plane upper-layer data carried by the transmission and a quantity of bits occupied by the control plane upper-layer signaling carried by the transmission.

Exemplarily, the indication information is used to indicate the lengths of data, signaling, and at least one padding bit carried by the transmission, that is, the indication information is used to indicate a quantity of bits occupied by the user plane upper-layer data carried by the transmission, a quantity of bits occupied by the control plane upper-layer signaling carried by the transmission, and a quantity of bits occupied by the at least one padding bit carried by the transmission.

Exemplarily, the indication information is used to indicate the length ratio between data and signaling carried by the transmission, that is, the indication information is used to indicate a ratio between a quantity of bits occupied by the signaling carried by the transmission and a quantity of bits occupied by the data carried by the transmission. For example, in a case where the signaling occupies 5 bits and the data occupies 3 bits, the indication information is used to indicate that the length ratio between signaling carried by the transmission and data carried by the transmission is 5:3.

Exemplarily, the indication information is used to indicate the length ratio of data, signaling, and at least one padding bit carried by the transmission, that is, the indication information is used to indicate a ratio of a quantity of bits occupied by the data carried by the transmission, a quantity of bits occupied by the signaling carried by the transmission, and a quantity of bits occupied by the at least one padding bit carried by the transmission. For example, in a case that the data occupies 5 bits, the signaling occupies 5 bits, and the padding bits occupy 3 bits, the indication information indicates that the length ratio of data, signaling, and padding bits carried by the transmission is 5:5:3.

According to the technical solutions provided in the embodiments of the present disclosure, the user plane upper-layer data and the control plane upper-layer signaling are directly carried and transmitted via the physical layer. The physical layer directly acquires, from a protocol layer that generates user plane upper-layer data, the user plane upper-layer data to be transmitted, and acquires, from a protocol layer that generates control plane upper-layer signaling, the control plane upper-layer signaling to be transmitted, eliminating the need for transfer through PDCP, RLC, and MAC layers, thereby reducing the complexity of the protocol stack, simplifying the transmission processing procedures, and further reducing the power consumption of devices.

The foregoing embodiments only use the sending process as an example for illustration. The technical solutions provided in the present disclosure is also be applicable to a reception process.

In some embodiments, the above method is applicable to a communication process between terminal devices.

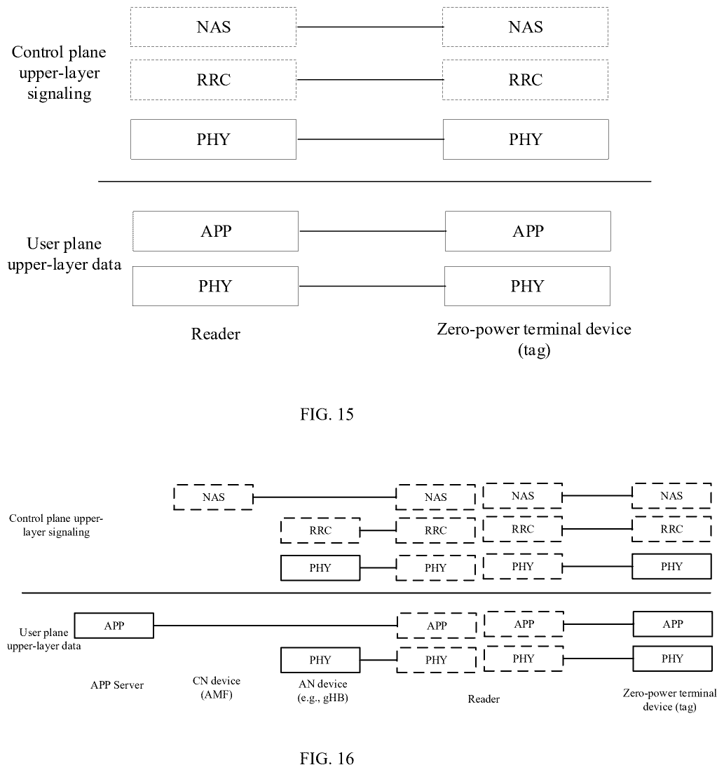

Exemplarily, as illustrated in FIG. 15, a communication process between a zero-power terminal device (e.g., a tag) and a reader is illustrated as an example.

For user plane upper-layer data:

On the tag side, a physical layer receives user plane upper-layer data from a first protocol layer, and the user plane upper-layer data is transmitted to a reader via the physical layer. For example, the physical layer on the tag side receives application layer data from an application layer on the tag side, and the application layer data is transmitted to the reader via the physical layer.

On the reader side, a physical layer receives the user plane upper-layer data from the tag, and the user plane upper-layer data is transmitted to a first protocol layer via the physical layer. For example, the physical layer on the reader side receives the application layer data from the tag, and the application layer data is transmitted to an application layer on the reader side via the physical layer.

For control plane upper-layer signaling:

On the tag side, a physical layer receives control plane upper-layer signaling from a second protocol layer, and the control plane upper-layer signaling is transmitted to a reader via the physical layer. For example, the physical layer on the tag side receives RRC layer signaling from an RRC layer on the tag side, and the RRC layer signaling is transmitted to the reader via the physical layer.

On the reader side, a physical layer receives the control plane upper-layer signaling from the tag, and the control plane upper-layer signaling is transmitted to a second protocol layer via the physical layer. For example, the physical layer on the reader side receives the RRC layer signaling from the tag, and the RRC layer signaling is transmitted to an RRC layer on the reader side via the physical layer.

In some embodiments, the above method is applicable to a communication process between a terminal device and a network device. The communication between the terminal device and the network device is direct or relayed by a relay device, which is not limited in the present disclosure.

Exemplarily, as illustrated in FIG. 16, a communication process between a zero-power terminal device (e.g., a tag) and a network device via a relay device (e.g., a reader) is illustrated as an example.

For user plane upper-layer data:

On the tag side, a physical layer receives user plane upper-layer data from a first protocol layer, and the user plane upper-layer data (of the tag) is transmitted to a reader via the physical layer. For example, the physical layer on the tag side receives application layer data from an application layer on the tag side, and the application layer data is transmitted to the reader via the physical layer.

On the reader side, a physical layer receives the user plane upper-layer data (of the tag) from the tag, and the user plane upper-layer data (of the tag) is transmitted to a first protocol layer via the physical layer. For example, the physical layer on the reader side receives the application layer data from the tag, and the application layer data is transmitted to an application layer on the reader side via the physical layer.

The physical layer on the reader side may transmit user plane upper-layer data (of the reader) to an AN device (e.g., a gNB), and the application layer on the reader side may transmit application layer data to an application server (APP server). For example, the physical layer on the reader side transmits the user plane upper-layer data to the gNB. A physical layer of the gNB receives the user plane upper-layer data, and forwards the user plane upper-layer data to the APP server. The APP server decodes the user plane upper-layer data.

On the AN device side, a physical layer receives the user plane upper-layer data (of the reader) from the reader.

On the APP server side, the application layer data from the reader is received.

For control plane upper-layer signaling:

On the tag side, a physical layer receives control plane upper-layer signaling (of the tag) from a second protocol layer, and the control plane upper-layer signaling (of the tag) is transmitted to a reader via the physical layer. For example, the physical layer on the tag side receives RRC layer signaling from an RRC layer on the tag side, and the RRC layer signaling is transmitted to the reader via the physical layer.

On the reader side, a physical layer receives the control plane upper-layer signaling (of the tag) from the tag, and the control plane upper-layer signaling (of the tag) is transmitted to a second protocol layer via the physical layer. For example, the physical layer on the reader side receives the RRC layer signaling from the tag, and the RRC layer signaling is transmitted to an RRC layer on the reader side via the physical layer.

The physical layer on the reader side may transmit control plane upper-layer signaling (of the reader) to an AN device, the RRC layer on the reader side may transmit RRC signaling to the AN device, and an NAS on the reader side may transmit NAS signaling to a CN device (e.g., an AMF). For example, the physical layer on the reader side transmits the RRC signaling to the AN device, and a physical layer of the AN device receives the RRC signaling. For example, the physical layer on the reader side transmits the NAS signaling to the AN device. The physical layer of the AN device receives the NAS signaling and forwards the NAS signaling to the CN device. The CN device decodes the NAS signaling.

On the CN device side, an NAS receives the NAS signaling from the reader.

On the AN device side, the physical layer receives the control plane upper-layer signaling (of the reader) from the reader, and an RRC layer receives the RRC signaling from the reader.

According to the technical solutions provided in the embodiments of the present disclosure, the communication procedures are significantly simplified, and the power consumption of devices is reduced.

The following are apparatus embodiments of the present disclosure that may be used to implement the method embodiments of the present disclosure. For details that are not disclosed in the apparatus embodiments of the present disclosure, reference is made to the method embodiments of the present disclosure.

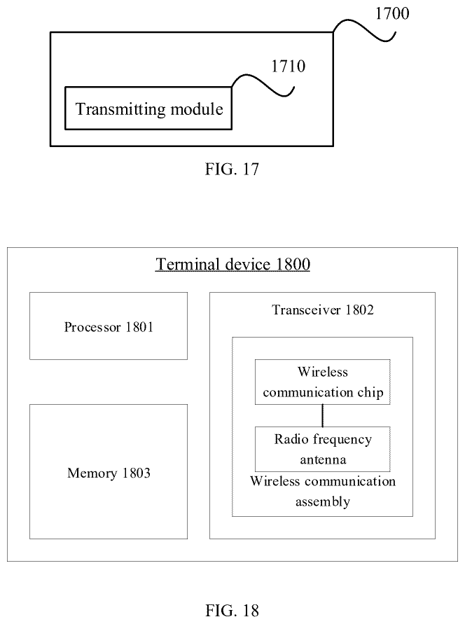

Referring to FIG. 17, a block diagram of an apparatus for wireless communication according to some embodiments of the present disclosure is illustrated. The apparatus has functions for implementing the examples of the method for wireless communication described above, and the functions may be implemented by hardware or by executing corresponding software on hardware. The apparatus may be the terminal device described above, or may be provided in the terminal device. As illustrated in FIG. 17, the apparatus 1700 includes: a transmitting module 1710.

The transmitting module is configured to transmit user plane upper-layer data directly carried by a physical layer.

In some embodiments, the user plane upper-layer data includes at least one of: IP-based upper-layer data; Ethernet-based upper-layer data; unstructured upper-layer data; or application layer data.

In some embodiments, a first protocol layer for generating the user plane upper-layer data resides above the physical layer.

The transmitting module 1710 is configured to transmit, via the first protocol layer, the user plane upper-layer data directly to the physical layer, and transmit, via the physical layer, the user plane upper-layer data received from the first protocol layer.

In some embodiments, the transmitting module 1710 is further configured to transmit control plane upper-layer signaling directly carried by the physical layer.

In some embodiments, the control plane upper-layer signaling includes at least one of: RRC layer signaling; or NAS signaling.

In some embodiments, a second protocol layer for generating the control plane upper-layer signaling resides above the physical layer.

The transmitting module 1710 is configured to transmit, via the second protocol layer, the control plane upper-layer signaling directly to the physical layer, and transmit, via the physical layer, the control plane upper-layer signaling received from the second protocol layer.

In some embodiments, the second protocol layer for generating the control plane upper-layer signaling is a protocol layer for an interface between terminals or a protocol layer for an interface between a terminal and a network.

In some embodiments, the transmitting module 1710 is further configured to transmit indication information via a physical layer control channel, wherein the indication information is used to indicate information related to transmission.

In some embodiments, the indication information indicates at least one of: presence of data in the transmission; presence of signaling in the transmission; presence of at least one padding bit in the transmission; presence of data and signaling in the transmission; presence of data and at least one padding bit in the transmission; presence of signaling and at least one padding bit in the transmission; presence of data signaling and at least one padding bit in the transmission; a length of data carried by the transmission; a length of signaling carried by the transmission; a length of at least one padding bit carried by the transmission; lengths of data and signaling carried by the transmission; lengths of data and at least one padding bit carried by the transmission; lengths of signaling and at least one padding bit carried by the transmission; lengths of data, signaling, and at least one padding bit carried by the transmission; a length ratio between data and signaling carried by the transmission; a length ratio between data and at least one padding bit carried by the transmission; a length ratio between signaling and at least one padding bit carried by the transmission; or a length ratio of data, signaling, and at least one padding bit carried by the transmission.

In some embodiments, the apparatus 1700 is a zero-power terminal device, or the apparatus 1700 is installed in a zero-power terminal device.

According to the technical solutions provided in the embodiments of the present disclosure, the user plane upper-layer data is directly carried and transmitted via the physical layer. The physical layer directly acquires, from a protocol layer that generates user plane upper-layer data, the user plane upper-layer data to be transmitted, eliminating the need for transfer through PDCP, RLC, and MAC layers, thereby reducing the complexity of the protocol stack, simplifying the communication procedures, and further reducing the power consumption of devices.

Referring to FIG. 18, a schematic structural diagram of a terminal device according to some embodiments of the present disclosure is illustrated. The terminal device 1800 includes: a processor 1801, a transceiver 1802, and a memory 1803. The transceiver 2102 is configured to implement the functions of the transmission module 1710.

The processor 1801 includes one or more processing cores, and the processor 1801 executes various functional applications and performs information processing by running software programs and modules. The processor 1801 is configured to perform steps other than the transmission and reception steps performed by the terminal device in the above method embodiments.

The transceiver 1802 may include a receiver and a transmitter, which may implemented, for example, as the same wireless communication assembly. The wireless communication assembly may include a wireless communication chip and a RF antenna. The transceiver 1802 is configured to perform the transmission and/or reception steps performed by the terminal device in the above method embodiments.

The memory 1803 may be connected to the processor 1801 and the transceiver 1802.

The memory 1803 may be configured to store one or more computer programs executable by the processor, and the processor 1801 is configured to execute the one or more computer programs to perform the steps in the above method embodiments.

In addition, the memory may be implemented by any type of volatile or non-volatile storage devices or a combination thereof, including, but not limited to: magnetic or optical discs, electrically erasable programmable read-only memories, erasable programmable read-only memories, static random-access memories, read-only memories, magnetic memories, flash memories, and programmable read-only memories.

In some exemplary embodiments, the processor 1801 is configured to transmit user plane upper-layer data directly carried by a physical layer.

For details that are not specified in the embodiments, reference may be made to the embodiments described above, and the details are not repeated herein.

The embodiments of the present disclosure further provide a computer-readable storage medium storing one or more computer programs, wherein the one or more computer programs, when loaded and run by a processor, cause the processor to perform the method for wireless communication described above. In some embodiments, the computer-readable storage medium includes: a read-only memory (ROM), a random-access memory (RAM), a solid state drive (SSD), an optical disc, or the like. The RAM includes a resistance random-access memory (ReRAM) and a dynamic random-access memory (DRAM).

The embodiments of the present disclosure further provide a chip including programmable logic circuitry and/or one or more program instructions. The chip, when running, is configured to perform the method for wireless communication described above.

The embodiments of the present disclosure further provide a computer program product. The computer program product includes one or more computer programs stored in a computer-readable storage medium, wherein the one or more computer programs, when read from the computer-readable storage medium and run by a processor, cause the processor to perform the method for wireless communication described above.

It should be understood that the term “indication” mentioned in the embodiments of the present disclosure may be a direct indication, an indirect indication, or an indication that an association relationship is present. For example, “A indicates B” may mean that A directly indicates B, for example, B may be obtained through A; or may mean that A indirectly indicates B, for example, A indicates C through which B may be obtained; or may mean an association relationship is present between A and B.

In the description of the embodiments of the present disclosure, the term “corresponding” may indicate a direct corresponding relationship or an indirect corresponding relationship between two items, or an association relationship between the two items, or a relationship such as indicating and being indicated, configuring and being configured, or the like.

The term “a plurality of” herein means two or more. The term “and/or” describes an association relationship of associated objects, and it indicates three types of relationships. For example, the phrase “A and/or B” means (A), (B), or (A and B). The character “/” usually indicates an “or” relationship between the associated objects.

The phrase “greater than or equal to” herein may refer to either “greater than or equal to” or strictly “greater than”; similarly, “less than or equal to” may refer to either “less than or equal to” or strictly “less than.”

In addition, the serial numbers of the processes described herein only exemplifies one possible execution sequence among the processes. In some other embodiments, the above processes may also be executed without following the numbering sequence. For example, two processes with different serial numbers are executed simultaneously or in an order reverse to the order shown in the figures. This is not limited in the embodiments of the present disclosure.

A person skilled in the art should be aware that in the foregoing one or more examples, the functions described in the embodiments of the present disclosure may be implemented by hardware, software, firmware, or any combination thereof. The functions, when implemented by software, may be stored in a computer-readable medium or transmitted as at least one instruction or code on the computer-readable medium. The computer-readable medium includes a computer storage medium and a communication medium. The communication medium includes any medium that facilitates transfer of a computer program from one place to another. The storage medium may be any available medium accessible by a general-purpose computer or a special-purpose computer.

Described above are merely exemplary embodiments of the present disclosure and are not intended to limit the present disclosure. Any modification, equivalent replacement, and improvement, and the like, made within the spirit and principle of the present disclosure shall be fall within the protection scope of the present disclosure.

1. A method for wireless communication, performed by a terminal device, the method comprising:
transmitting user plane upper-layer data directly carried by a physical layer.

2. The method according to claim 1, wherein the user plane upper-layer data comprises at least one of:
Internet Protocol (IP)-based upper-layer data;
Ethernet-based upper-layer data;
unstructured upper-layer data; or
application layer data.

3. The method according to claim 1, wherein:
a first protocol layer for generating the user plane upper-layer data resides above the physical layer; and
transmitting the user plane upper-layer data directly carried by the physical layer comprises:
transmitting, via the first protocol layer, the user plane upper-layer data directly to the physical layer; and
transmitting, via the physical layer, the user plane upper-layer data received from the first protocol layer.

4. The method according to claim 1, further comprising:
transmitting control plane upper-layer signaling directly carried by the physical layer.

5. The method according to claim 4, wherein the control plane upper-layer signaling comprises at least one of:
radio resource control (RRC) layer signaling; or
non-access stratum (NAS) signaling.

6. The method according to claim 4, wherein:
a second protocol layer for generating the control plane upper-layer signaling resides above the physical layer; and
transmitting the control plane upper-layer signaling directly carried by the physical layer comprises:
transmitting, via the second protocol layer, the control plane upper-layer signaling directly to the physical layer; and
transmitting, via the physical layer, the control plane upper-layer signaling received from the second protocol layer.

7. The method according to claim 4, wherein a second protocol layer for generating the control plane upper-layer signaling is a protocol layer for an interface between the terminal device and another terminal device or a protocol layer for an interface between the terminal device and a network.

8. The method according to claim 1, further comprising:
transmitting indication information via a physical layer control channel, wherein the indication information is used to indicate information related to transmission.

9. The method according to claim 8, wherein the indication information is used to indicate at least one of:
presence of data in the transmission;
presence of signaling in the transmission;
presence of at least one padding bit in the transmission;
presence of data and signaling in the transmission;
presence of data and at least one padding bit in the transmission;
presence of signaling and at least one padding bit in the transmission;
presence of data signaling and at least one padding bit in the transmission;
a length of data carried by the transmission;
a length of signaling carried by the transmission;
a length of at least one padding bit carried by the transmission;
lengths of data and signaling carried by the transmission;
lengths of data and at least one padding bit carried by the transmission;
lengths of signaling and at least one padding bit carried by the transmission;
lengths of data, signaling, and at least one padding bit carried by the transmission;
a length ratio between data and signaling carried by the transmission;
a length ratio between data and at least one padding bit carried by the transmission;
a length ratio between signaling and at least one padding bit carried by the transmission; or
a length ratio of data, signaling, and at least one padding bit carried by the transmission.

10. The method according to claim 1, wherein the terminal device is a zero-power terminal device.

11. A terminal device, comprising:
a processor; and
a memory storing one or more computer programs;
wherein the one or more programs, when loaded and run by the processor, cause the processor to:
transmit user plane upper-layer data directly carried by a physical layer.

12. The terminal device according to claim 11, wherein the user plane upper-layer data comprises at least one of:
Internet Protocol (IP)-based upper-layer data;
Ethernet-based upper-layer data;
unstructured upper-layer data; or
application layer data.

13. The terminal device according to claim 11, wherein:
a first protocol layer for generating the user plane upper-layer data resides above the physical layer; and
wherein the one or more programs, when loaded and run by the processor, cause the processor to:
transmit, via the first protocol layer, the user plane upper-layer data directly to the physical layer, and
transmit, via the physical layer, the user plane upper-layer data received from the first protocol layer.

14. The terminal device according to claim 11, wherein the one or more programs, when loaded and run by the processor, cause the processor to transmit control plane upper-layer signaling directly carried by the physical layer.

15. The terminal device according to claim 14, wherein the control plane upper-layer signaling comprises at least one of:
radio resource control (RRC) layer signaling; or
non-access stratum (NAS) signaling.

16. The terminal device according to claim 14, wherein:
a second protocol layer for generating the control plane upper-layer signaling resides above the physical layer; and
the one or more programs, when loaded and run by the processor, cause the processor to:
transmit, via the second protocol layer, the control plane upper-layer signaling directly to the physical layer, and
transmit, via the physical layer, the control plane upper-layer signaling received from the second protocol layer.

17. The terminal device according to claim 14, wherein:
a second protocol layer for generating the control plane upper-layer signaling is a protocol layer for an interface between the terminal device and another terminal device or a protocol layer for an interface between the terminal device and a network.

18. The terminal device according to claim 11, wherein the one or more programs, when loaded and run by the processor, cause the processor to transmit indication information via a physical layer control channel, wherein the indication information is used to indicate information related to transmission.

19. The terminal device according to claim 18, wherein the indication information is used to indicate at least one of:
presence of data in the transmission;
presence of signaling in the transmission;
presence of at least one padding bit in the transmission;
presence of data and signaling in the transmission;
presence of data and at least one padding bit in the transmission;
presence of signaling and at least one padding bit in the transmission;
presence of data signaling and at least one padding bit in the transmission;
a length of data carried by the transmission;
a length of signaling carried by the transmission;
a length of at least one padding bit carried by the transmission;
lengths of data and signaling carried by the transmission;
lengths of data and at least one padding bit carried by the transmission;
lengths of signaling and at least one padding bit carried by the transmission;
lengths of data, signaling, and at least one padding bit carried by the transmission;
a length ratio between data and signaling carried by the transmission;
a length ratio between data and at least one padding bit carried by the transmission;
a length ratio between signaling and at least one padding bit carried by the transmission; or
a length ratio of data, signaling, and at least one padding bit carried by the transmission.

20. The terminal device according to claim 11, wherein the terminal device is a zero-power terminal device.
